(19) United States
(12) Patent Application Publication
(10) Pub. No.: US 2008/0028466 A1
(43) Pub. Date: Jan. 31, 2008

(54) SYSTEM AND METHOD FOR RETRIEVING INFORMATION FROM A STORAGE MEDIUM

(76) Inventor: Michael Burtscher, Longmont, CO (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/460,015

(22) Filed: Jul. 26, 2006

(51) Int. Cl. G06F 12/14

(52) U.S. Cl. 726/23

(57) ABSTRACT

A system and method for scanning files on a computer-readable storage medium is described. In one embodiment the method includes retrieving a first piece of information from a first file located at a first portion of the computer-readable storage medium and caching the first piece of information from the first file before retrieving information from a second stored file located at a second portion of the computer-readable storage medium. In addition, a second piece of information from the first file located at a third portion of the computer readable medium is retrieved and analyzed to determine whether the first file is a potential pestware file.

### RELATED APPLICATIONS

The present application is related to commonly owned and assigned application Ser. No. 11/104,202, filed Apr. 12, 2005 entitled System and Method for Accessing Data From a Data Storage Medium; and application Ser. No. 11/105,978, filed Apr. 14, 2005 entitled System and Method for Scanning Obfuscated Files for Pestware which are incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect pestware, but scanning a system for pestware typically requires a system to look at files stored in a data storage device (e.g., disk) on a file by file basis. This process of scanning files is frequently time consuming, and as a consequence, users must wait a substantial amount of time to find out the results of a system scan. Even worse, some users elect not to perform a system scan because they do not want to, or cannot, wait for a scan to be completed. Accordingly, current software is not always able to scan and remove pestware in a convenient manner and will most certainly not be satisfactory in the future.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the invention may be characterized as a system and method for scanning files on a computer-readable storage medium. In this embodiment the method includes retrieving a first piece of information from a first file located at a first portion of the computer-readable storage medium and caching the first piece of information before retrieving information from a second stored file located at a second portion of the computer-readable storage medium. In addition, a second piece of information from the first file located at a third portion of the computer readable medium is retrieved and analyzed to determine whether the first file is a potential pestware file.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of a computer that is protected in accordance with several embodiments of the present invention;

FIG. 2 is flowchart depicting a method in accordance with many embodiments of the present invention; and

FIG. 3 is a partial and exploded view of one embodiment of the file storage device of FIG. 1.

### DETAILED DESCRIPTION

In prior art computer systems, when a user desires to perform a general scan of a collection of files (e.g., for pestware), prior art scanning software typically utilizes the operating system to enumerate (e.g., identify) each file in the collection of files to be scanned. Once the files are enumerated, the prior art scanning software then accesses, utilizing the operating system, each enumerated file, file by file, in the order the files are enumerated by the operating system.

Unfortunately, the order in which typical operating systems enumerate files may be determined by the directory tree that the files are organized by instead of the physical location of the files in the computer system's file storage device. In the context of a disk drive for example, the order in which files are enumerated may have very little, if any, relation to the location of the files on the disk. As a consequence, the head of a disk dive may have to move across opposite ends of the disk surface to access two files that were juxtaposed in the list of files enumerated by the operating system.

Although the time it takes the head to jump between two disparate locations on a disk surface may be insignificant, when several enumerated files (e.g., several hundred or thousand files) are accessed, the amount of time required for the disk heads to traverse the disk surface, in aggregate, is substantial.

The above-identified, and commonly owned, application entitled System and Method for Accessing Data From a Data Storage Medium discloses among other subject matter, an improved technique for accessing a storage device in accordance with the physical location of files on the storage device, which substantially decreases the amount of time needed to scan a collection of files.

It has been found that pestware developers have used, and continue to utilize, obfuscation techniques (e.g., encryption and/or compression) to create pestware files that, at the very least, render detection of their pestware more difficult. The above identified application entitled System and Method for Scanning Obfuscated Files for Pestware discloses some exemplary obfuscation techniques and exemplary techniques for analyzing whether obfuscated files are pestware files. Consistent with the disclosed techniques (e.g., scanning selected portions of a file at one or more offsets from a reference point), it has been found beneficial to access two or more portions of a file that do not reside on continuous portions of a storage device (e.g., hard drive). As a consequence, scanning more than an initial portion (e.g., the first 500 Bytes) of a file has been found to be beneficial.

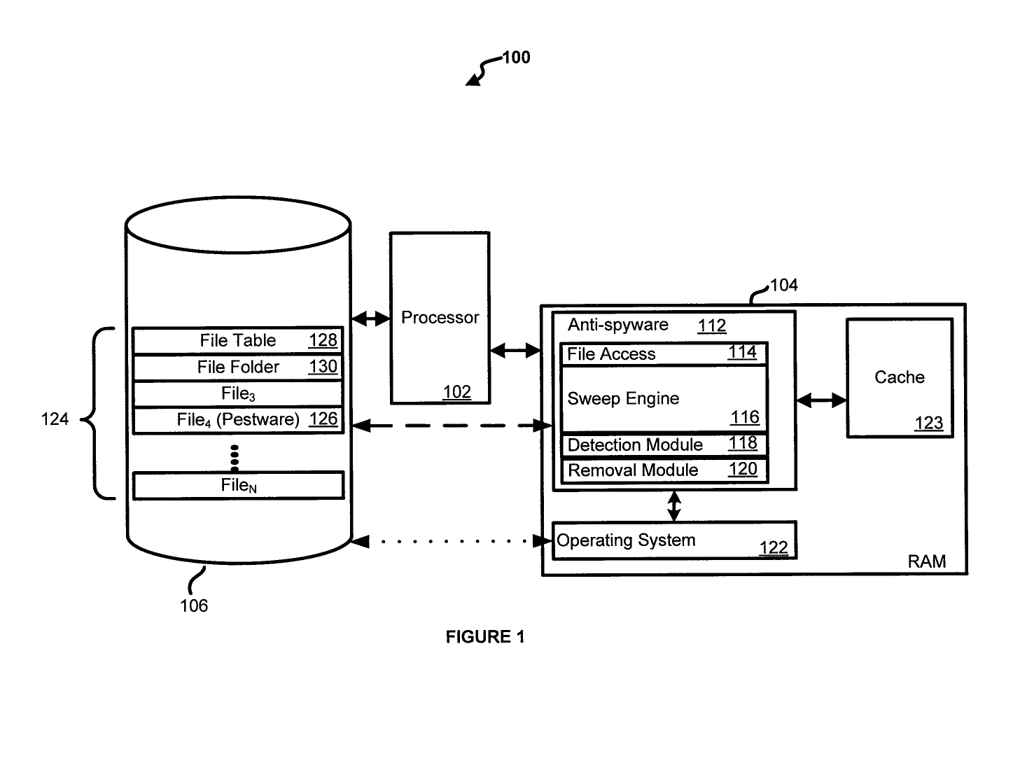

Referring now to the drawings, where like or similar elements are designated with identical reference numerals throughout the several views, and referring in particular to FIG. 1, shown is a block diagram 100 of a computer that is protected in accordance with one implementation of the present invention. The term “computer” is used herein to refer to any type of computer system, including personal computers, handheld computers, servers, firewalls, etc. This implementation includes a processor 102 coupled to memory 104 (e.g., random access memory (RAM)) and a file storage device 106.

As shown, the storage device 106 provides storage for a collection of N files 124, which includes a pestware file 126, a file table 128 and a file folder 130 among other files. The storage device 106 is described herein in several implementations as hard disk drive for convenience, but it is contemplated that other storage media may be utilized without departing from the scope of the present invention. For convenience, however, embodiments of the present invention are generally described herein with relation to disk-drive based systems. In addition, one of ordinary skill in the art will recognize in light of this disclosure that the storage device 106, which is depicted for convenience as a single storage device, may be realized by multiple (e.g., distributed) storage devices.

Although each of the N files 124 is depicted, for convenience, as a contiguous portion of the storage device 106, it should be recognized that in many instances several of the N files 124 may each be fragmented and dispersed over noncontiguous portions of the storage device 106.

The file table 128 in this embodiment is a file that includes an entry (also referred to herein as a record) for each of the files 124 on the data storage device 106 including the file table 128 itself and each of the other files. Each entry (not shown) in the file table 128 includes a set of attributes (also referred to herein as attribute information), which includes information about the corresponding file (e.g., file name(s), creation date, last-modified date, file type, alternate data streams, security information and pointers to data locations (also referred to herein as data runs). In one embodiment, as described further herein, the file table 128 is a Master File Table (MFT), which is organized in accordance with a new technology file system (NTFS) sold under the trade name of Microsoft Corp., but this is certainly not required.

In the exemplary embodiment, in addition to the file table 128 and N files 124, folders (e.g., the file folder 130), are stored on the storage device 106 as files that have corresponding entries in the file table 128. The entries for folders include index attributes that contain or point to an index of the files and subfolders within that folder.

As shown, an anti-spyware application 112 in the exemplary embodiment includes a file access module 114, a sweep engine 116, a detection module 118 and a removal module 120, which are implemented in software and are executed from the memory 104 by the processor 102. In addition, an operating system 122 is depicted as running from memory 104 and a cache 123 is depicted in memory 104.

The software 112 can be configured to operate on personal computers (e.g., handheld, notebook or desktop), servers or any device capable of processing instructions embodied in executable code. Moreover, one of ordinary skill in the art will recognize that alternative embodiments, which implement one or more components (e.g., the anti-spyware 112) in hardware, are well within the scope of the present invention.

The cache utilized by the sweep engine 116 may vary depending upon several factors including the size of the memory 104 and how efficient the pestware-scanning algorithm is desired to be. It has been found, for example, that a majority of files on typical computers are less than one megabyte, and of the files that are less than a megabyte, a majority are not fragmented and can be processed immediately without the need to cache them. As file size increases, however, so does the likelihood that the file will be fragmented. According to several embodiments, it is the fragments of these relatively large files that may need to be cached for a longer period of time, and by doing so, the time it takes to scan a storage device (e.g., a hard drive) can be substantially reduced.

It has been found that a cache size of at least 8 or 16 megabytes is effective. Although a larger cache may certainly be utilized (e.g., 32, 64 or 128 megabytes) to further reduce scan times (e.g., relative to an 8 or 16 megabyte-sized cache), it has been found that a relatively large cache (e.g., 128 megabytes) may only marginally improve performance relative to a smaller cache (e.g., 64 megabytes).

In the present embodiment, the operating system 122 is not limited to any particular type of operating system and may be operating systems provided by Microsoft Corp. under the trade name WINDOWS (e.g., WINDOWS 2000, WINDOWS XP, and WINDOWS NT). Additionally, the operating system may be an open source operating system such operating systems distributed under the LINUX trade name. For convenience, however, embodiments of the present invention are generally described herein with relation to WINDOWS-based systems. Those of skill in the art can easily adapt these implementations for other types of operating systems or computer systems.

Although certainly not required, in the exemplary embodiment depicted in FIG. 1, the file access module 114 is configured to access information from the storage device 106. In some embodiments, for example, the file access module 114 is configured to directly access (e.g., without using calls to the operating system 122) the storage device 106 to retrieve information from the storage device 106. In addition to substantially increasing the rate at which information is retrieved from the storage device 106, the exemplary embodiment also circumvents particular varieties of pestware (e.g., rootkits), which are known to patch, hook, or replace system calls with versions that hide information about the pestware. Additional information about directly accessing (e.g., without using OS API calls) a storage device and removing locked files is found in U.S. application Ser. No. 11/145,593, Attorney Docket No. WEBR-009/00US, entitled “System and Method for Neutralizing Locked Pestware Files,” which is incorporated herein by reference in its entirety.

In some variations, the file access module 114 accesses the file table 128 (e.g., directly) to locate attribute information for each of the files and builds, by accessing each entry of the file table 128, a file structure for an entire volume of files on the storage device 106. In this way, every file and its path may be resolved to ensure locations of a file are properly identified, and that the file can be properly removed, if desired and/or necessary.

In several embodiments of the present invention, the sweep engine 116 expedites the scanning of the N files 124 for pestware (e.g., the pestware file 126) in the data storage device 106 by retrieving information from the files 124 according to their physical locations on the data storage device 106 instead of the order the files are enumerated by the operating system 122. In this way, the time required for the mechanism(s) (e.g., a disk head) within the file storage device to access each file is substantially reduced.

In addition, as described further herein, the sweep engine 116 is configured to store file information in the cache 123 so that if it is desirable to analyze information from two non-contiguous portions of a file for pestware, a first portion of the file may be cached while the sweep engine 116 continues to scan the storage device 106, according to the physical location of the information on the storage device 106, until the second portion of the file is found on the storage device 106.

When the storage device 106 is realized by a disk drive, for example, if two portions of the pestware file 126 are separated by several clusters, after a first portion of the pestware file 126 is cached, the sweep engine 116 may continue to scan and the detection module 118 may continue to analyze portions of other files located on clusters that are interposed between the first and second portions of the pestware file 126. And once the second portion of the pestware file 126 is reached, it may be analyzed by the detection module 118 in connection with the first portion of the pestware file 126.

In some variations, a limit is placed on the size of the file that the sweep engine 116 may cache. In some embodiments for example, the size of files that are cached are limited to files that are about 1 megabyte in size so that the cache does not immediately fill with large files. As discussed, a majority of files on typical computers are less than 1 megabyte, so most files would still potentially be cached during a scan. In some embodiments, files that are larger than the maximum size may be scanned in their entirety, without regard to their location on the storage device 106. Because a relatively small number of files are larger than one megabyte, scanning these larger files by known techniques, while scanning smaller files in accordance with embodiments described herein, still provides substantial reductions in the time required to scan the storage device 106.

In accordance with several embodiments of the present invention, the detection module 114 is configured to analyze file information gathered by the sweep engine 116 so as to identify both obfuscated (e.g., encrypted pestware) as discussed further herein and pestware that is identifiable by established techniques (e.g., by comparing information in the files with known pestware definitions.)

In some embodiments, only one or more selected portions of a file are retrieved and analyzed unless is desirable to retrieve additional portions. In some embodiments for example, a first portion (e.g., a first cluster) of a file is analyzed to determine whether it is desirable to have any additional portions of the file available before analyzing the retrieved information for indicia of pestware. As an example, if the first portion of the file reveals that the file is a text file, then the first portion of the text file is analyzed for indicia of pestware and subsequent portions of the file may be ignored, but if the file is an executable file, then one or more additional portions of the executable file may be retrieved from the storage device. As another example, if an analysis of a first portion and second portion of the file indicates with substantial certainty that the file is a pestware file, then the sweep engine 116 may subsequently ignore subsequent portions of that file. It has been found that, in many instances a determination may be made as to whether a file is malicious or not with only a small portion (e.g., 30%) of an entire file. As a consequence, an effective scan for pestware may be carried out, while substantially reducing scan times by selectively retrieving only portions of each file on the storage device.

In other embodiments, however, the sweep engine 116 is configured to retrieve and cache an entire file before the detection module 118 analyzes the file for indicia of pestware. Although reading an entire file may take longer than selectively analyzing portions of a file, because most files on a typical computer are relatively small and are not fragmented, a majority of files will easily fit within the cache 123 and may be quickly analyzed and dumped so that the cache 123 does not fill.

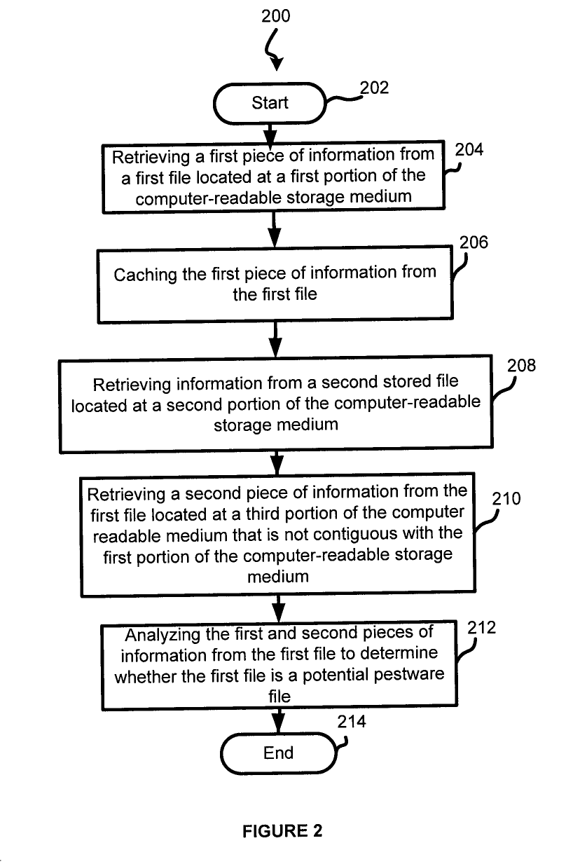

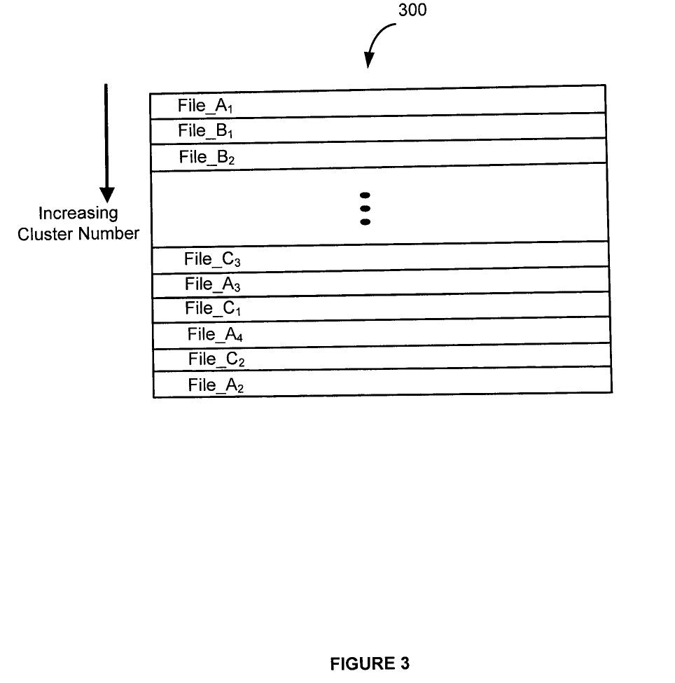

Referring next to FIG. 2, shown is a flowchart depicting an exemplary process for accessing information from a storage device. While referring to FIG. 2, simultaneous reference will be made to FIGS. 1 and 3, but is should be recognized that the process depicted in FIG. 2 is certainly not limited to the exemplary embodiments depicted in FIGS. 1 and 3. As shown in FIG. 2, initially a first piece of information is retrieved from a first file and cached (Blocks 202, 204, 206).

In some variations, in advance of retrieving information from any files, the file structure for the volume of files is built by reading entries for each file in a file table (e.g., the file table 128). In this way, every file and its path may be resolved to ensure locations of a file are properly identified so as to be retrievable and removable, if desired and/or necessary.

As depicted in FIG. 2, the first piece of information from the first file is cached (e.g., in the cache 123), and information from a second stored file, located at a second portion of the storage device is retrieved (Block 208). In many embodiments, the information from the second stored file resides in a cluster that is contiguous with the first piece of information from a first file, but this is certainly not required, and as discussed further herein, the information from the second stored file may be retrieved after skipping one or more clusters.

Referring to FIG. 3, for example, depicted is a partial and exploded view of the of an exemplary embodiment of the file storage device 106 depicted in FIG. 1. As shown, the storage device 306 includes three exemplary files: File A, File B and File C, which are depicted in terms of constituent clusters that are distributed over the storage device 306. As shown, each of file A, B and C is depicted by portions that are numbered in accordance with each portion's relative position within each file. For example, File_A₁, File_B₁ and File_C₁ are the beginning portions of files A, B and C respectively, and may, for example, include a header portion, which provides information about each file (e.g., an entry point). As depicted in FIG. 3, each of files A, B and C may be fragmented and the fragments may be arranged on the storage device such that an ending portion of a file (e.g., File_C₃) may reside on a lower cluster than a beginning portion of the file (e.g., File_C₁).

In accordance with the process depicted in FIG. 2, a first portion of File A, depicted as File_A₁, may be retrieved and cached, and information from file B, which is located on a portion of the storage device 306 that is contiguous with the first portion of file A, may be retrieved (and in some instances analyzed) before any other portions of file A are retrieved.

Although not required, in many embodiments, at least the first cluster of a file is initially read, and in some variations, if the file includes information in other clusters that are contiguous with the first cluster, information from the contiguous clusters is also retrieved. As shown in FIG. 3, for example, contiguous portions of file B (e.g., File_B₁ and File_B₂) may be retrieved without substantially slowing scan times because the reading mechanism (e.g., disk head) of the storage device 106, 306 does not make any jumps.

Referring again to FIG. 2, after retrieving information from a second stored file, a second piece of information from the first file located at a third portion of the storage device 106 is retrieved and the first and second pieces of information from the first file are analyzed to determine whether the first file is a pestware file (Blocks 210, 212).

Referring back to FIG. 3, for example, a second portion of file A (e.g., File_A₃) may be retrieved and analyzed in connection with the first portion of file A (e.g., File A₁) that was cached at Block 206, after retrieving portions of file B (e.g., File_B₁ and File_B₂).

In some embodiments, a file is not analyzed until the entire file is cached. As a consequence, in these embodiments, the second piece of information from the first file is retrieved (Block 208) as a matter of course before any analysis of the file begins. As a consequence, the analysis of the first and second pieces of information from the first file (Block 212) may include analysis of several portions of the first file. Referring again to FIG. 3 as an example, File A₄ and File A₂ may be gathered and analyzed along with File A₁ and File A₃, the first and second portions of file A.

In other embodiments, the second piece of information from the first file is retrieved (Block 210) in response to a determination (e.g., by the detection module 118) that additional information is needed from the first file to assess whether the file is a pestware file. As an example, the first cluster, or if contiguous, the first few clusters of each file, may be added to a queue of clusters, which are organized in the queue by cluster (e.g., by cluster number) so that when the list of clusters is scanned (e.g., sequentially by cluster number), the amount of jumping by the disk head is reduced.

As the files are scanned in this embodiment, if a determination is made that additional clusters of a file are needed (e.g., to perform offset scanning), the first cluster(s) of the file remains cached and those additional clusters of the file are added to the queue so that when the disk head reaches those clusters, the portions of the file in those clusters may be scanned along with the cached portion of the file. In variations of this embodiment, both the first and last cluster of each file is initially placed in the queue of clusters to be scanned.

If, however, a determination is made (e.g., based upon an analysis of the first cluster(s)), that no additional clusters are needed to assess whether the file is, or is not, a pestware file, then other portions (e.g., clusters) of the file are not added to the queue and are skipped, thereby avoiding the time consuming process of retrieving an entire file.

In some embodiments where clusters of the storage device are selectively scanned, only the clusters that include the first (and in some variations the first and last) portions of a file are added to the scanning queue, and unless an assessment of the first (and in some variations, the first and last portions) of the file is inconclusive, no other portions of the files are retrieved. In these embodiments, however, analyzing each file may require multiple iterations of scanning the storage device 106, 306 (e.g., sequentially from low cluster to high cluster). Referring again to FIG. 3, for example, a scan of the storage device 306 may begin by retrieving File A₁ followed by retrieving File_B₁ (and optionally File_B₂), but File_C₃ may be skipped at this point because it may not be needed to assess whether file C is a pestware file. Continuing this example, unless an analysis of File A₁ indicated that it was desirable to scan File A₃ it is also skipped, but because File_C₁ is the first portion of file C, it is retrieved and analyzed.

If the analysis of File_C₁ indicates it is desirable to have the File_C₃ portion of file C scanned, the cluster on which File_C₃ resides is added to the end of the list of clusters to read, and unless the clusters where File_A₄, File_C₂, or File_A₂ reside have been added to the list of clusters to scan, they are also skipped.

Although certainly not required, in some variations, once the disk head reaches the last cluster of the disk, it reverses direction and scans clusters in the cluster list from high cluster number to low cluster number; thus avoiding moving the disk head all the way to the beginning of the disk.

For example, once File_A₂ is read or skipped, and the end of the storage device 306 is reached, clusters in the queue of clusters are read beginning with the clusters closet to the end of the storage device 306 (e.g., File_A₂). As a consequence, if the cluster where File_C₃ resides is the only cluster in the queue, then File_A₂, File_A₄, File_C₂, or is then retrieved and analyzed in connection with File_C₁.

In conclusion, the present invention provides, among other things, a system and method for scanning and analyzing files stored on a computer readable medium. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for scanning files on a computer-readable storage medium comprising:
retrieving a first piece of information from a first file located at a first portion of the computer-readable storage medium;
caching the first piece of information from the first file;
retrieving information from a second stored file located at a second portion of the computer-readable storage medium while the first piece of information from the first file is cached, wherein the first and second portions of the computer-readable storage medium are contiguous portions of the computer-readable storage medium;
retrieving a second piece of information from the first file located at a third portion of the computer readable medium, wherein the first and third portions of the computer readable medium are not contiguous portions of the computer-readable storage medium; and
analyzing the first and second pieces of information from the first file to determine whether the first file is a potential pestware file.

2. The method of claim 1, wherein the second piece of information from the first file is retrieved in response to a determination, after an analysis of the first piece of information, that an analysis of the second piece of information is desired.

3. The method of claim 1 including caching the second piece of information from the first file and analyzing the first and second pieces of information after both the first and second pieces of information are cached.

4. The method of claim 1, wherein retrieving the first piece of information includes retrieving at least one cluster of contiguous information.

5. The method of claim 1 including analyzing the information from the second stored file and determining that no additional information from the second file is desired to be retrieved.

6. The method of claim 1 including accessing a file table of the computer-readable medium to assemble a file structure for the files on the computer-readable medium so as to be able to identify physical locations on the computer-readable medium where portions of each file are stored.

7. The method of claim 1, wherein retrieving the first and second pieces of information include retrieving the first and second pieces of information while circumventing an operating system.

8. The method of claim 1, including:
analyzing, while the first piece of information from the first file is cached, the information from the second stored file to determine whether the second file is a potential pestware file.

9. A system for scanning files on a computer-readable storage medium comprising:
a sweep engine adapted to:
receive and cache a first piece of information from a first file located at a first portion of the computer-readable storage medium;
receive information from a second stored file located at a second portion of the computer-readable storage medium while the first piece of information from the first file is cached;
receive a second piece of information from the first file located at a third portion of the computer readable medium, the first and third portions of the computer readable medium being noncontiguous; and
a detection module configured to receive the information from the second stored file and analyze the information from the second stored file for indicia of pestware while the first piece of information from the first file is cached.

10. The system of claim 9, including a file access module configured to retrieve the first and second pieces of information from the first file and information from the second stored file while substantially circumventing an operating system of a computer utilizing the computer-readable storage medium.

11. The system of claim 10 including a file information aggregator in communication with the file access module, wherein the file information aggregator is configured to receive, from a file table of the computer-readable storage medium, a data attribute within an entry for the file table, the data attribute including pointers to the locations where the file table is stored on the data storage device, and wherein the file information aggregator is configured to build, in a an executable memory of the computer, a file structure for a volume of the computer-readable storage medium using the attribute information.

12. The system of claim 9, wherein the sweep engine is adapted retrieve the second piece of information from the first file in response to the detection module indicating additional analysis of the first file is desired to determine whether the first file is a pestware-related file.

13. The system of claim 9, wherein the sweep engine is configured to cache the second piece of information from the first file and the detection module is configured to including analyze the first and second pieces of information after both the first and second pieces of information are cached.

14. The system of claim 9, wherein the detection module is configured to analyze the information from the second stored file and, in response to the detection module determining that no additional information from the second file being retrieved, the sweep engine is configured to skip additional portions of the second file on the computer-readable storage medium.

15. The system of claim 9, wherein the detection module is configured to analyze, while the first piece of information from the first file is cached, the information from the second stored file to determine whether the second file is a potential pestware file.
